(19) United States
(12) Patent Application Publication
(10) Pub. No.: US 2014/0372211 A1
(43) Pub. Date: Dec. 18, 2014

(54) REAL-TIME ADVERTISEMENT BASED ON COMMON POINT OF ATTRACTION OF DIFFERENT VIEWERS

(71) Applicant: International Business Machines Corporation, Armonk, NY (US)

(72) Inventors: Barry Alan Kritt, Raleigh, NC (US); Sarbajit Kumar Rakshit, Kolkata (IN)

(73) Assignee: International Business Machines Corporation, Armonk, NY (US)

(21) Appl. No.: 14/079,450

(22) Filed: Nov. 13, 2013

Related U.S. Application Data
(63) Continuation of application No. 13/918,772, filed on Jun. 14, 2013.

(51) Int. Cl. G06Q 30/02; H04N 7/18

(52) U.S. Cl. CPC G06Q 30/0251; H04N 7/18
USPC 705/14.49

(57) ABSTRACT

A method for providing real-time advertisements includes using one or more cameras to determine a direction of focus of attention of a plurality of persons by determining a direction of the head of each person of the plurality of persons located in a vicinity of a plurality of products. The method includes extrapolating the direction of focus for each person of the plurality of persons and determining, for each product of the plurality of products, a number of persons of the plurality of persons that have a direction of focus on the product where the determination is based on the extrapolated direction of focus for each person. The method includes ranking each product based on the number of persons with a direction of focus on a product of the plurality of products and displaying an advertisement where content of the advertisement is based on the ranking of each product.

### CROSS-REFERENCE TO RELATED APPLICATIONS

This application is a continuation U.S. patent application Ser. No. 13/918,772 entitled “REAL-TIME ADVERTISEMENT BASED ON COMMON POINT OF ATTRACTION OF DIFFERENT VIEWERS” and filed on Jun. 14, 2013 for Barry Alan Kritt, et al. and the entire contents of the above mentioned application is incorporated herein by reference for all purposes.

### FIELD

The subject matter disclosed herein relates to advertising and more particularly relates to targeted advertising based upon the focus of attention of a plurality of persons.

### BACKGROUND

Businesses advertise their products and services in many different ways through a variety of marketing channels. Some businesses advertise only to specific demographic groups and most businesses tailor their advertisements to these target audiences. An advertisement is more effective when consumers are paying attention and have an actual interest in the good and/or service being promoted. Thus, businesses will often promote their goods and services alongside popular television shows, radio programs, or web sites enjoyed by their target consumers. For example, snack food companies and athletic apparel manufacturers will advertise their products during televised sporting events like the Super Bowl. However, often advertising is based on old data so that advertising might not target what consumers are interested in at the time the consumers are shopping.

### BRIEF SUMMARY

An apparatus for advertising includes a focal direction module, a focus extrapolation module, a product focus module, a ranking module, and an advertising module. In one embodiment, the focal direction module uses one or more cameras to determine a direction of focus of attention of a plurality of persons by determining a direction of the head of each person of the plurality of persons. The plurality of persons is located in a vicinity of a plurality of products. In another embodiment, the focus extrapolation module extrapolates the direction of focus for each person of the plurality of persons. In another embodiment, the product focus module determines, for each product of the plurality of products, a number of persons of the plurality of persons that have a direction of focus on the product. The determination is based on the extrapolated direction of focus for each person. In another embodiment, the ranking module ranks each product based on the number of persons with a direction of focus on a product of the plurality of products. In another embodiment, the advertising module displays an advertisement in view of at least a portion of the plurality of persons. Content of the advertisement is based on a ranking by the ranking module.

In one embodiment, the one or more cameras are positioned to have a range of view of more than 180 degrees. In another embodiment, each product of the plurality of products is viewed by the one or more cameras from a plurality of viewing angles totaling more than 180 degrees in a horizontal plane and/or receives a direction of focus from a plurality of viewing angles totaling more than 180 degrees in a horizontal plane. In an alternative embodiment, the direction of focus for each person of the plurality of persons is substantially perpendicular to the plane of the person's face. In another embodiment, the product focus module determines the number of persons of the plurality of persons that have a direction of focus on a product at regular time intervals. In another embodiment, the ranking for each product of the plurality of products factors in a sales history of the product.

In one embodiment, the ranking of each product of the plurality of products factors in a duration of time that a direction of focus is maintained on the product. In another embodiment, the ranking of each product of the plurality of products factors in an existing inventory of the product. In another embodiment, the advertising module displays the advertisement using an electronic display, a tablet computer, a phone, and/or a printer. In another embodiment, the advertisement may include a video, an e-mail, a text message, and/or a printed coupon. In another embodiment, the advertisement includes a display located within a vicinity of the product being advertised, a vicinity of a point of sale, and/or a view of a person that has a direction of focus on the product being advertised.

In one embodiment, the product receiving the most direction of focus has the highest ranking and the advertisement includes a promotion of the product with the highest ranking. In another embodiment, the advertisement includes a promotion of a ranked product, a product related to a ranked product, a product that is complementary to a ranked product, a product similar to a ranked product, a product used with a ranked product, a product that includes a substitute for a ranked product, and/or a service related to a ranked product. In another embodiment, the advertisement includes one or more advertisements for a plurality of ranked products of the plurality of products. In another embodiment, the apparatus includes a tracking module that, for each product of the plurality of products, tracks sales of the product. The ranking module uses the sales information of the tracked sales to rank the plurality of products. In a further embodiment, the tracking module tracks, for a zone within the area of the plurality of products, one or more of the number of directions of focus touching the zone and the duration of time that a direction of focus touches the zone.

A system for advertising includes one or more cameras, a processor, and a monitoring apparatus executing at least partially on the processor. The monitoring apparatus includes a focal direction module, a focus extrapolation module, a product focus module, a ranking module, and an advertising module. In one embodiment, the focal direction module uses one or more cameras to determine a direction of focus of attention of a plurality of persons by determining a direction of the head of each person of the plurality of persons. The plurality of persons is located in a vicinity of a plurality of products. In another embodiment, the focus extrapolation module extrapolates the direction of focus for each person of the plurality of persons. In another embodiment, the product focus module determines, for each product of the plurality of products, a number of persons of the plurality of persons that have a direction of focus on the product. The determination is based on the extrapolated direction of focus for each person. In another embodiment, the ranking module ranks each product based on the number of persons with a direction of focus on a product of the plurality of products. In another embodiment, the advertising module displays an advertisement in view of at least a portion of the plurality of persons. Content of the advertisement is based on a ranking by the ranking module.

A method for advertising includes using one or more cameras to determine a direction of focus of attention of a plurality of persons by determining a direction of the head of each person of the plurality of persons. The plurality of persons is located in a vicinity of a plurality of products. The method includes extrapolating the direction of focus for each person of the plurality of persons. The method includes determining, for each product of the plurality of products, a number of persons of the plurality of persons that have a direction of focus on the product. The determination is based on the extrapolated direction of focus for each person. The method includes ranking each product based on the number of persons with a direction of focus on a product of the plurality of products and displaying an advertisement in view of at least a portion of the one or more persons. Content of the advertisement is based on the ranking of each product.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for providing real-time advertisements based upon direction of focus;

FIG. 2 is a schematic block diagram illustrating one embodiment of an apparatus for providing real-time advertisements based upon direction of focus;

FIG. 3 is a schematic block diagram illustrating another embodiment of an apparatus for providing real-time advertisements based upon direction of focus;

FIG. 4 is a schematic flow chart illustrating one embodiment of an apparatus for providing real-time advertisements based upon direction of focus; and

FIG. 5 is a schematic flow chart illustrating another embodiment of an apparatus for providing real-time advertisements based upon direction of focus.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

The computer program product may be integrated into a client, server and network environment by providing for the computer program product to coexist with applications, operating systems and network operating systems software and then installing the computer program product on the clients and servers in the environment where the computer program product will function.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

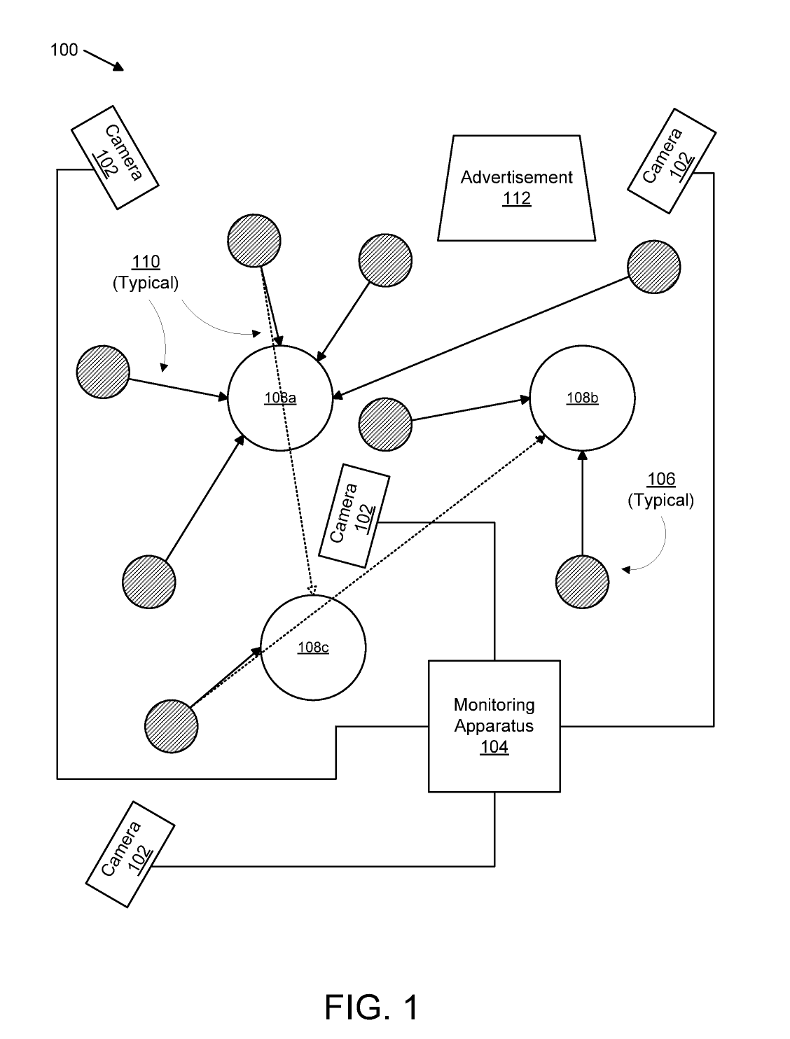

FIG. 1 is a schematic drawing illustrating one embodiment of a system 100 for providing real-time advertisement based upon direction of focus. The system 100 includes one or more cameras 102, a monitoring apparatus 104, a plurality of persons (i.e. people) 106 (106, as used herein may include one person or several people), a plurality of products 108a, 108b, 108c (collectively “108”), a direction of focus 110, and an advertisement 112, which are described below.

The system 100 includes one or more cameras 102 connected to a monitoring apparatus 104. In one embodiment, using one or more cameras 102, the monitoring apparatus 104 observes a plurality of persons 106 in the vicinity of a plurality of products 108 to provide targeted advertisements in real-time to these people 106. The people 106 may be individuals in a store, mall, a car dealership, an amusement park, a convention center, a museum, a public space, or the like. The products 108 can include food, clothing, automobiles, furniture, appliances, and/or other goods. The products 108 can be arranged in any number of geometric configurations, such as straight lines, circles, or a random distribution. For example, the products 108 may be food items sitting on a shelf in a supermarket aisle or clothing displays in a department store. As another example, the products 108 may be automobiles parked in a showroom. At any given time, people 106 may view a product (e.g. 108a) from a number of different directions and angles, including from all directions or only certain directions. For example, a person can view items on a shelf or clothing in a display window from the front, and to a certain degree, from off to the side. At the same time, an automobile on a showroom floor or a sculpture in the middle of a room at a museum may be viewed by several people 106 from all directions.

In another embodiment, the cameras 102 are positioned to view the plurality of persons 106 and products 108 from a variety of angles. In one embodiment, the cameras 102 may view the people 106 in three dimensions. Numerous types of cameras may be used with the system 100. For example, a camera 102 may be a commercial closed circuit camera, a wireless camera, and/or a webcam. A camera's orientation may be fixed and thus only manually adjustable. Alternatively, a camera's rotation may be remotely controlled by an operator or can be automated using motion sensing technology. An example of a remote controlled camera is a PTZ (Pan-Tilt-Zoom) camera commonly used in casinos and hotels. In another embodiment, the one or more cameras 102 may be positioned in the middle of an area containing a plurality of products 108. For example, a camera may be placed in the ceiling of a store or showroom to observe one or more customers walking amongst products 108 on a sales floor. In another example, a closed circuit camera may be placed on a shelf in a grocery store aisle near or above eye level. In a different embodiment, the cameras 102 may be placed around the perimeter of the area holding the plurality of products 108, such as one or more corners of a store. In an alternative embodiment, a camera 102 may be positioned to face in substantially one direction, such as in a store window display pointing outward in the direction of passersby.

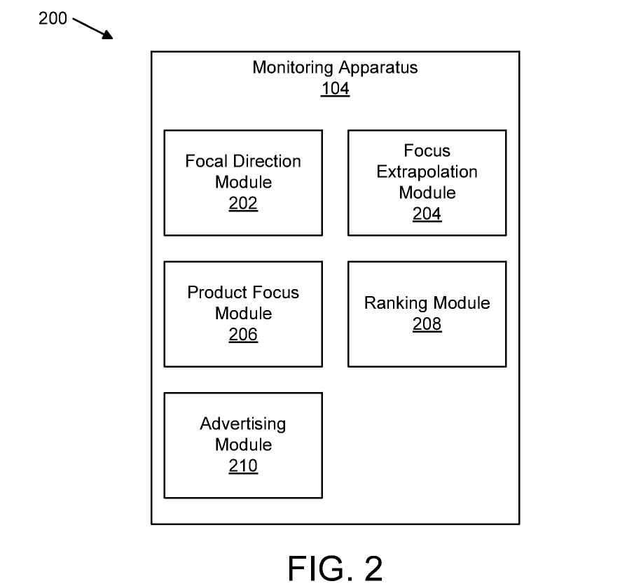

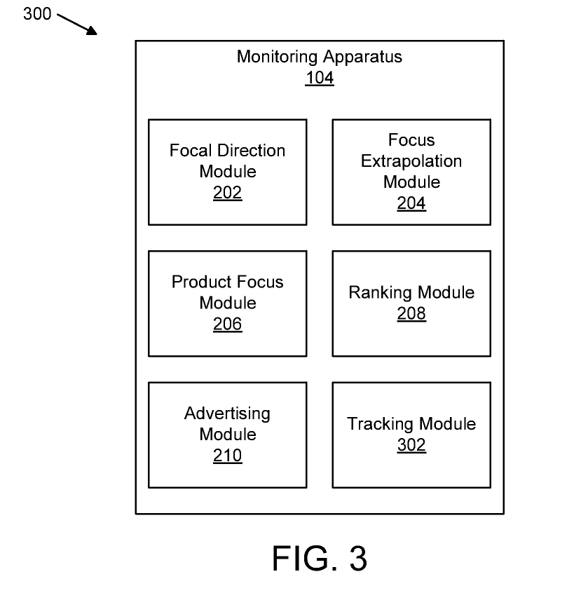

The cameras 102 may be directly or indirectly connected to the monitoring apparatus 104. For example, a camera 102 can be directly connected to the monitoring apparatus 104 through one or more cables or through a wireless connection using specific radio frequencies. Alternatively, a camera 102 may be connected to the monitoring apparatus 104 through a network, such as a local area network (“LAN”), a wide area network (“WAN”), the internet, or a wireless network (e.g., Wi-Fi, cellular, etc.). One of skill in the art will recognize alternative ways that a camera 102 can be connected to a monitoring apparatus 104. Through the use of one or more cameras 102, the monitoring apparatus 104 is able to determine the direction of focus 110 for a plurality of persons 106 in the vicinity of the products 108. The monitoring apparatus 104 may then provide targeted advertising as described with regard to the apparatuses 200, 300 of FIGS. 2 and 3.

FIG. 2 is a schematic drawing illustrating one embodiment of an apparatus 200 for providing real-time advertisements based upon direction of focus 110. The apparatus 200 includes one embodiment of a monitoring apparatus 104 with a focal direction module 202, a focus extrapolation module 204, a product focus module 206, a ranking module 208, and an advertising module 210, which are described below.

In one embodiment, the focal direction module 202 analyzes video captured by the one or more cameras 102 to identify a direction of focus 110 for the plurality of persons 106. The focal direction module 202, in one embodiment, uniquely identifies each person 106, for example, to avoid miscounting the number of directions of focus 110. In one instance, uniquely identifying each person 106 is accomplished by positioning each camera 102 to capture an exclusive zone within the area holding the products 108. For example, at a certain point in time, a person's image may be captured by one camera 102.

In another embodiment, the cameras 102 have overlapping fields of view and a partition is assigned to an area viewed by a camera. For example, one camera 102 may have a field of view that is 30 feet wide with 10 feet overlapping a field of view of another camera 102. The overlapping 10 feet of the first camera 102 may be ignored so that each camera 102 monitors a unique zone. Alternatively, the focal direction module 202 may keep track of the physical locations of each person 106 and each product 108 within the area of the products 108, such that if multiple cameras capture separate images of the same person 106, the focal direction module will be able to determine that the same person 106 appears in both images based upon the physical location of the person 106.

The focal direction module 202 may identify the direction of focus 110 of a person 106 in different ways. For example, the focal direction module 102 may determine a direction of focus 110 of a person 106 by identifying which way the person 106 is facing. If a person's face is visible, in one embodiment, the direction of focus 110 of the person 106 may be accomplished by identifying the person's face through facial recognition software and then determining the tilt of the person's face. In one embodiment, the direction of focus 110 of a person 106 is substantially perpendicular to the direction of the person's face. Alternatively, a person's direction of focus 110 may be determined by tracking the person's gaze, including but not limited to the direction of the person's pupils. In this embodiment, a person's direction of focus 110 may be substantially parallel to the direction of the person's gaze. In one embodiment, if a person's face is not visible, the focal direction module 102 may determine the person's direction of focus 110 based on one or more views of the person's head, including the tilt and rotation of the head. For example, a view of the back of a person's head may indicate that the person's direction of focus 110 is substantially opposite from the direction of the back of the person's head. In another embodiment, in the event that a person's head is not visible, the focal direction module 102 may determine the person's direction of focus 110 based upon the orientation of the person's body, such as the orientation of the person's shoulders and/or torso. In this case, a person's direction of focus 110 may be substantially perpendicular to a plane formed by the person's shoulders and the midpoint of his or her lower back.

The focal extrapolation module 204, in one embodiment, extrapolates the direction of focus 110 for each person 106. For example, the focus 110 extrapolation module 204 may use the direction of focus 110 of a person 106 found by the focal direction module 106 to extrapolate a line of direction of focus 110 of a person 106. The line may be used by the product focus module 206 to determine if direction of focus 110 is on a product 108. The focus extrapolation module 204 may, for instance, use a location of the person 106 in an area being monitored by the cameras 102, a direction of focus 110 of the person 106, dimensions of the area being monitored, etc. to extrapolate the direction of focus 110 of the person 106.

In another embodiment, the focus extrapolation module 204 may extrapolate the direction of focus 110 by determining an area of focus for a person 106. For example, the focal extrapolation module 106 may extrapolate to include a zone that includes a range. The range may include, for example, an angle on each side of a line that corresponds to a direction of focus 110. For instance, if the focus extrapolation module 204 extrapolates a direction of focus 110 of a person 106 to determine a line from the person 106, the focus extrapolation module 204 may extrapolate the line to include a zone that is 5 degrees either side of the line.

The focus extrapolation module 204, in another embodiment, determines an area of focus in the vicinity of the products 108 based upon a spatial projection of each person's direction of focus 110. For example, an area of focus of a person 106 may be a column of space extending in the direction of the person's direction of focus 110. The dimensions for an area of focus may be pre-defined, or set dynamically based upon a variety of factors, including but not limited to, (i) the height of a camera 102, a person 106, or the ceiling; (ii) the distance between a person 106 and the border of the area holding the plurality of products 108, another person 106, or a visual obstruction (e.g., support column); and (iii) the width of the person's head or torso.

In another embodiment, the product focus module 206 determines, for each product in a plurality of products 108, the number of persons within the plurality of persons 106 that have a direction of focus 110 on the product 108. There are different ways to determine the number of persons 106 that have a direction of focus 110 on a product 108. In one embodiment, the focus module 206 counts, for each product (e.g. 108a), the number of areas of focus intersecting the product 108a or an area assigned to a product 108a. A direction of focus 110 may, for example, intersect more than one product (e.g. 108a, 108c). The product focus module 206, in one embodiment, determines that a direction of focus 110 is on the two or more products 108 that intersect the direction of focus 110. In another embodiment, the product focus module 108 determines that the direction of focus 110 of a person 106 is the product 108 nearest the person 106 that intersects the direction of focus 110 of the person 106.

In another embodiment, the product focus module 206 determines, within the area holding the plurality of products 108, regions where areas of focus overlap. For the product(s) 108 nearest or intersecting an overlap region, the product focus module 206 may determine the number of persons that have a direction of focus 110 on the product 108 as the sum of (i) the number of overlap regions touching the product 108 and (ii) the number of directions of focus 110 forming the each overlap region. Other ways of determining the number of persons 106 having a direction of focus 110 on a product may include a timing component. For example, the product focus module 206 may calculates the number of directions of focus 110 received by a product at set time intervals (e.g., every five seconds). The product focus module 206, for example, may have a sampling rate and may determine the number of persons 106 that have a direction of focus 110 on a product 108 at each sampling time. In another embodiment, the product focus module 206 determines, for each product 108, a number of persons 106 with a direction of focus 110 on a product 108 using a window of time. In one embodiment, the product focus module 206 determines the number of persons 106 with a direction of focus 110 on a product 108 during a fixed window of time. The window of time may be, for example, 10 minutes.

In another embodiment, the product focus module 206 determines the number of persons 106 with a direction of focus 110 on a product 108 during a moving window of time. For example, the moving window may average the number of persons 106 with a direction of focus 110 on a product 108 or may update a counter that count up for new occurrences of a direction of focus 110 on a product 108 while decreasing the counter for older occurrences at the back end of the window. In another embodiment, the product focus module measures the total duration of time that a direction of focus 110 is maintained on a product 108. One of skill in the art will recognize other ways for the product focus module 206 to determine a number of persons 106 with a direction of focus 110 on a product 108.

The ranking module 208, in one embodiment, ranks each product 108 of the plurality of products 108 based on the number of persons 106 with a direction of focus 110 on the product 108. In one example, the ranking module 208 assigns the highest ranking to the product 108 receiving the most directions of focus 110. Other ranking methodologies used by the ranking module 208 may incorporate other factors in addition to the number of directions of focus 110 received when assigning rankings. For example, a ranking methodology may take into account the sales history of a product, such that given two products receiving nearly the same number of directions of focus 110, the product with the better (or worse) sales history will receive a higher ranking. A different ranking methodology may take into account the duration of time that a direction of focus 110 is maintained on a product, such that given two products receiving nearly the same number of directions of focus 110, the product receiving longer lasting directions of focus 110 may be ranked higher. Yet another ranking methodology may also take into account the existing inventory of a product 108, such that given two products 108 receiving nearly the same number of directions of focus 110, the product 108 that is better stocked may receive a higher ranking.

In one embodiment, the ranking module 208 determines a single product 108 with a highest rank. In another embodiment, the ranking module 208 returns a list of products 108 in an order reflective of the ranking determined by the ranking module 208. In another embodiment, the ranking module 208 updates product rankings at a pre-determined rate. For example, the ranking module 208 may update product rankings each time the product focus module 206 updates a count for each product 108 of a number of persons 106 with a direction of focus 110 on a product 108. One of skill in the art will recognize other ways that the ranking module 208 may determine a product ranking.

The advertising module 210, in one embodiment, displays an advertisement 112 in view of at least one person 106 in a plurality of persons 106 in the vicinity of the plurality of products 108 based upon a ranking by the ranking module 208. The advertising module 210 may display the advertisement 112 in a variety of formats, including but not limited to a video, an e-mail, a text message, a printed coupon, or some combination thereof. One skilled in the art will recognize other advertising formats. The advertisement module 210 may display the advertisement 112 by a variety of devices, including an electronic display, a tablet computer, a phone, a printer, etc. The advertising module 210 may display the advertisement 112 in a variety of locations, including but not limited to within the vicinity of the product being advertised, within the vicinity of a point of sale (e.g., checkout counter), or within a view of a person that has a direction of focus 110 on the product being advertised.

The content of the advertisement 112 may also vary based upon a ranking by the ranking module 208. In one embodiment, the advertising module 210 displays the advertisement 112 as a promotion for the product 108 with the highest ranking. Alternatively, the advertising module 210 may display the advertisement 112 as a promotion for multiple ranked products 108. The advertisement 112 is not limited to being a promotion of a ranked product. For example, the advertising module 210 may display an advertisement 112 that promotes a product related to a ranked product 108 (e.g., mop and broom). Alternatively, the advertising module 210 may display an advertisement 112 that promotes a complementary product (e.g., peanut butter and jelly).

As another example, the advertising module 210 may display an advertisement 112 that promotes a similar product (e.g., cheddar cheese and swiss cheese made by the same company). In another embodiment, the advertising module 210 displays an advertisement 112 that promotes a product used with a ranked product 108 (e.g., socks and athletic shoes). In a particular embodiment, the advertising module 210 displays an advertisement 112 that promotes a product that can substitute for a ranked product 108 (e.g., different brand of facial tissue). In another embodiment, the advertising module 210 displays an advertisement 112 that can also promote a service related to a ranked product 108 (e.g., dry cleaning services and clothes). One of skill in the art will recognize other ways that the advertisement module 210 may display an advertisement based on the product ranking of the ranking module 208.

FIG. 3 is a schematic block diagram illustrating one embodiment of an apparatus 300 for providing real-time advertisements based upon direction of focus 110. The apparatus 300 includes another embodiment of the monitoring apparatus 104 with a focal direction module 202, a focus extrapolation module 204, a product focus module 206, a ranking module 208, an advertising module 210, which are substantially similar to those described above in relation to the apparatus 200 of FIG. 2. The monitoring apparatus 104 also includes tracking module 302, which is described below.

The tracking module 302, in one embodiment, records sales data for each product 108 of the plurality of products 108 that is used by the ranking module 208 to adjust the ranking of each product 108. For example, the tracking module 302 can record, over a set period of time, how many persons 106 had a direction of focus 110 on a product 108 versus the total sales for that product 108. The tracking module 302 may also track, over a set period of time, how long on average a person 106 maintains a direction of focus 110 on a product 108 versus the total sales for that product 108. The information recorded by the tracking module 302 may also be used to determine the effectiveness of an advertisement 112, a product's packaging, or a product's physical placement. For example, a low number of directions of focus 110 on a product 108 may indicate that the product 108 is unpopular, has unattractive packaging, has been placed in an undesirable location, etc. As another example, a product 108 with a high number of directions of focus 110 but low sales may indicate that the advertisement 112 for the product 108 is ineffective or that the price of the product 108 is too high. In another embodiment, the tracking module 302 may determine, over time, area(s) within the vicinity of the plurality of products are potentially strategically important for product placement. For example, the vicinity of the plurality of products 108 may be divided into individual zones. Each zone may be further divided into smaller vertical or horizontal zones, where one or more products are placed in each zone. The tracking module 302 may track, over a period of time, (i) the number of directions of focus 110 that touches on a zone, (ii) the total duration of time that a direction of focus 110 touches on a zone, or (iii) both. This information may be further combined with other data, such as the ranking or sales data of a product 108 within the zone, to determine the effectiveness of the location for product placement. For example, a zone that has the most number of directions of focus 110 touching on it or the longest duration of time where it is part of a direction of focus 110, but where the sales of the product(s) 108 placed within the zone are low, may indicate that the zone attracts direction of focus 110 independent of a product 108, and thus is a desirable location for product placement. Thus, the tracking module 312 may provide valuable feedback on both products 108 and related marketing strategies.

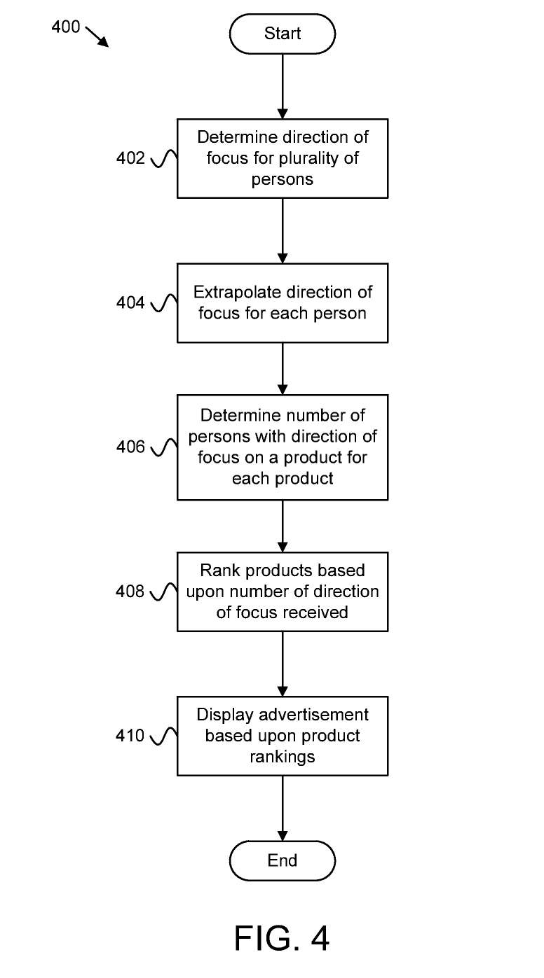

FIG. 4 is a schematic flow chart diagram illustrating one embodiment of a method 400 for providing real-time advertisements based upon direction of focus 110. The method 400 begins and uses one or more cameras 102 to determine 402 a direction of focus 110 of a plurality of persons 106. In one embodiment, the focal direction module 202 determines 402 the direction of focus 110 for each person 106 of the plurality of persons 106. The method 400 extrapolates 404 the direction of focus 110 for each person 106. In one embodiment, the focal extrapolation module 204 extrapolates 404 the direction of focus 110 for each person 106.

The method 400 determines 406, for each product 108, the number of persons 106 that have a direction of focus 110 on a product 108. In one embodiment, the product focus module 206 determines 406 the number of directions of focus 110 received by a product 108. The method 400 ranks 408 each product 108 based upon the number of directions of focus 110 received by the product 108. In one embodiment, the ranking module 208 ranks 408 the products 108. The method 400 displays 410 an advertisement 112 based upon the products' rankings and the method 400 ends. In one embodiment, the advertising module 210 displays 410 the advertisement 112.

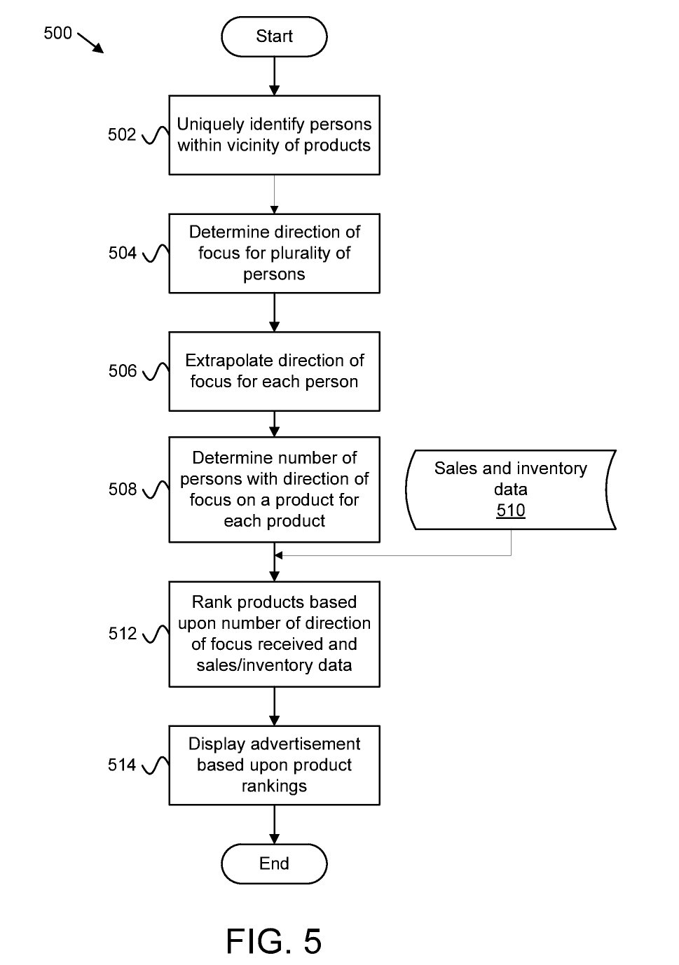

FIG. 5 is a schematic flow chart diagram illustrating another embodiment of a method 500 for providing real-time advertisements based upon direction of focus 110. The method 500 begins and uniquely identifies 502 a plurality of persons 106 within the vicinity of a plurality of products 108. In one embodiment, uniquely identifying 502 persons 106 with a direction of focus 110 on a product 108 helps to prevent double counting of persons 106 and directions of focus 110. The method 500 determines 504 the direction of focus 110 for each person 106. The method 500 also extrapolates 506 the direction of focus 110 for each person 106.

The method 500 determines 508, for each product 108, the number of persons 106 that have a direction of focus 110 on a product 108. The method 500 ranks 512 the plurality of products 108 based upon the number of directions of focus 110 a product 108 received and the sales/inventory data 510 for that product 108. In one embodiment, the ranking module 208 ranks 512 the products 108 and the tracking module 302 provides the sales/inventory data 510. The method 500 displays 514 an advertisement 112 based upon the products' rankings, and the method 500 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
using one or more cameras to determine a direction of focus of attention of a plurality of persons by determining a direction of the head of each person of the plurality of persons, the plurality of persons located in a vicinity of a plurality of products;
extrapolating the direction of focus for each person of the plurality of persons;
determining, for each product of the plurality of products, a number of persons of the plurality of persons that have a direction of focus on the product, the determination based on the extrapolated direction of focus for each person;
ranking each product based on the number of persons with a direction of focus on a product of the plurality of products; and
displaying an advertisement in view of at least a portion of the one or more persons, content of the advertisement based on the ranking of each product.

2. The method of claim 1, wherein the one or more cameras are positioned to have a range of view of more than 180 degrees.

3. The method of claim 1, wherein each product of the plurality of products is one or more of
viewed by the one or more cameras from a plurality of viewing angles totaling more than 180 degrees in a horizontal plane; and
receiving a direction of focus from a plurality of viewing angles totaling more than 180 degrees in a horizontal plane.

4. The method of claim 1, wherein the direction of focus for each person of the plurality of persons is substantially perpendicular to the plane of the person's face.

5. The method of claim 1, wherein the product focus module determines the number of persons of the plurality of persons that have a direction of focus on a product at regular time intervals.

6. The method of claim 1, wherein determining a number of persons of the plurality of persons that have a direction of focus on the product comprises determining the number of persons of the plurality of persons that have a direction of focus on a product within a window of time.

7. The method of claim 1, wherein determining a number of persons of the plurality of persons that have a direction of focus on the product comprises determining an amount of time that a direction of focus is maintained on a product.

8. The method of claim 1, wherein the ranking for each product of the plurality of products factors in a sales history of the product.

9. The method of claim 1, wherein the ranking of each product of the plurality of products factors in a duration of time that a direction of focus is maintained on the product.

10. The method of claim 1, wherein the ranking of each product of the plurality of products factors in an existing inventory of the product.

11. The method of claim 1, wherein displaying an advertisement comprises displaying the advertisement using a device comprising one or more of an electronic display, a tablet computer, a phone, and a printer.

12. The method of claim 1, wherein the advertisement comprises one or more of a video, an e-mail, a text message, and a printed coupon.

13. The method of claim 1, wherein the advertisement comprises a display located one or more of
within a vicinity of the product being advertised;
within a vicinity of a point of sale; and
within a view of a person that has a direction of focus on the product being advertised.

14. The method of claim 1, wherein the product receiving the most direction of focus has a highest ranking and the advertisement comprises a promotion of the product having the highest ranking.

15. The method of claim 1, wherein the advertisement comprises a promotion of one or more of
a ranked product;
a product related to a ranked product;
a product that is complementary to a ranked product;
a product similar to a ranked product;
a product used with a ranked product;
a product that comprises a substitute for a ranked product; and
a service related to a ranked product.

16. The method of claim 1, wherein the advertisement comprises one or more advertisements for a plurality of ranked products of the plurality of products.

17. The method of claim 1, further comprising, for each product of the plurality of products, tracking sales of the product and wherein the sales information of the tracked sales is used to rank the plurality of products.

18. The method of claim 17, wherein tracking sales of each product further comprises tracking, for a zone within the area of the plurality of products, one or more of
the number of directions of focus touching the zone; and
the duration of time that a direction of focus touches the zone.
